(19) United States
(12) Patent Application Publication
(10) Pub. No.: US 2025/0319766 A1
(43) Pub. Date: Oct. 16, 2025

(54) WHEEL HUB DISCONNECT SYSTEM

(71) Applicant: Fairfield Manufacturing Company, Inc., Lafayette, IN (US)

(72) Inventors: Darren ARNOLD, Tulsa, OK (US); Matthew P. RICHARDS, West Lafayette, IN (US); Patrick D. ELMORE, Zionsville (MI)

(21) Appl. No.: 18/632,763

(22) Filed: Apr. 11, 2024

(51) Int. Cl. B60K 17/02; B60B 27/00; B60K 7/00; B60K 17/04; F16D 11/14

(52) U.S. Cl. CPC B60K 17/02; B60B 27/0026; B60B 27/0047; B60K 7/0007; B60K 17/046; F16D 11/14; B60B 2320/10; B60B 2900/115; B60B 2900/531; B60B 2900/561; B60B 2900/731; B60K 2007/0092; F16D 2250/0084; F16D 2300/12

(57) ABSTRACT

Methods and systems for selectively engaging a wheel hub to an axle or a shaft of a propulsion source are described. The wheel hub includes a wheel hub disconnect cap that may be rotated to release and engage the wheel hub to the axle. The wheel hub disconnect cap may also traverse in a longitudinal direction to engage and release the wheel hub from the axle or shaft.

### TECHNICAL FIELD

The present disclosure relates to wheel hub of a vehicle. The wheel hub may be driven via an electric propulsion source.

### BACKGROUND AND SUMMARY

A vehicle may include wheels that are coupled to wheel hubs. The wheel hub may be driven via a propulsion source, such as an electric machine or motor. From time to time, it may be desirable to transport the vehicle so that the vehicle may perform work in another area or to move the vehicle so that its power source may be recharged, or because the machine has become inoperable. If the vehicle's wheel hubs remain coupled to the vehicle's propulsion source during transport of the vehicle, it may take more energy to move the vehicle, or be impossible to move. Therefore, it may be desirable to decouple wheel hubs from their propulsion sources to facilitate vehicle transport during at least some conditions.

The inventors have recognized the aforementioned challenges and developed a wheel disconnect system, comprising: a wheel hub disconnect cap, the wheel hub disconnect cap comprising a circular head and a circular shank, a first through hole, and a second through hole.

By fabricating a wheel hub disconnect cap, it may be possible to provide the technical result of producing drive system with a wheel hub that may be easily decoupled from a propulsion source. In particular, the wheel hub disconnect cap may be rotated and moved in a longitudinal direction of a wheel drive assembly to decouple or couple a wheel hub to a propulsion source.

The wheel hub disconnect system that is described herein may provide several advantages. For example, the wheel hub disconnect system provides a simplified way of disconnecting a wheel hub from a propulsion source. Another advantage may be that the wheel hub disconnect system may be applied to disconnect a wheel hub from a propulsion source with less possibility of losing pieces of the wheel hub disconnect system as compared to other wheel hub disconnect systems. Further, the wheel hub may be disconnected without loss of lubrication and all gears in the wheel hub remain in a gearbox.

It may be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE FIGURES

FIG. 1 is a plan view of an example vehicle that includes a wheel hub disconnect system.

FIG. 2A shows a cross-section of an electrified wheel drive unit where the wheel hub disconnect system is engaged.

FIG. 2B shows a cross-section of a portion of the electrified wheel drive unit where the wheel hub disconnect system is disengaged.

FIG. 3 shows a cross-section of a portion of the electrified wheel drive unit.

FIG. 4 shows a detailed cross-section of a wheel hub and wheel hub disconnect cap.

FIG. 5 shows a plan view of a wheel hub and wheel hub disconnect cap.

FIGS. 6-12 show views of a wheel hub disconnect cap during a wheel hub disconnecting and connecting sequence.

FIG. 13 shows a method for constructing a wheel disconnect system.

### DETAILED DESCRIPTION

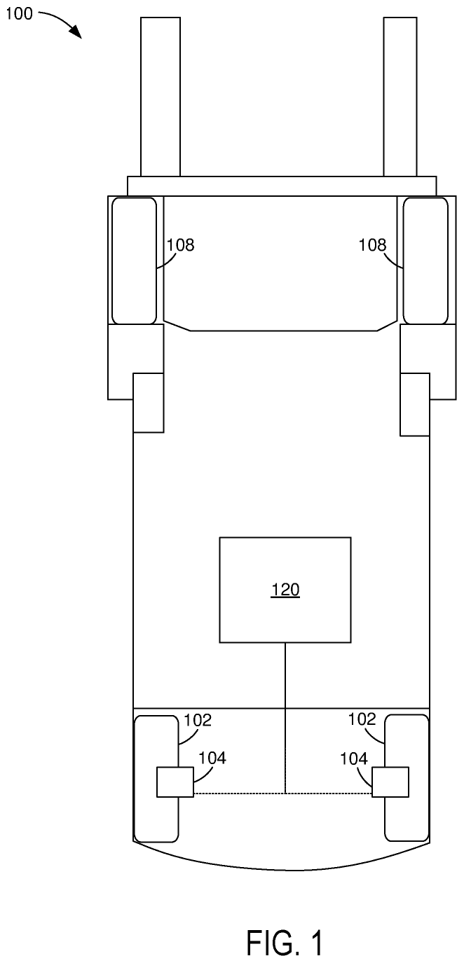

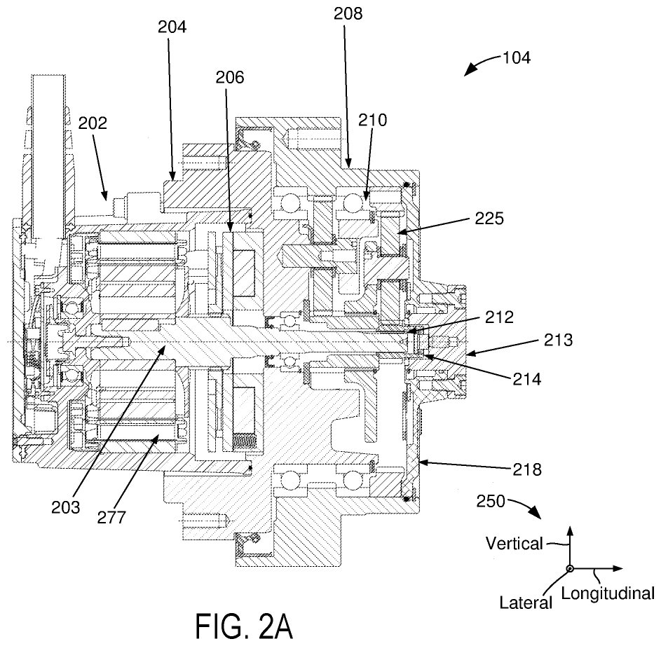

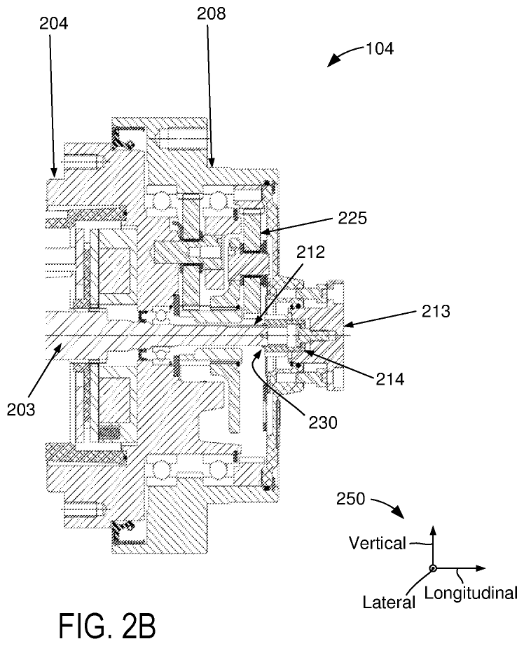

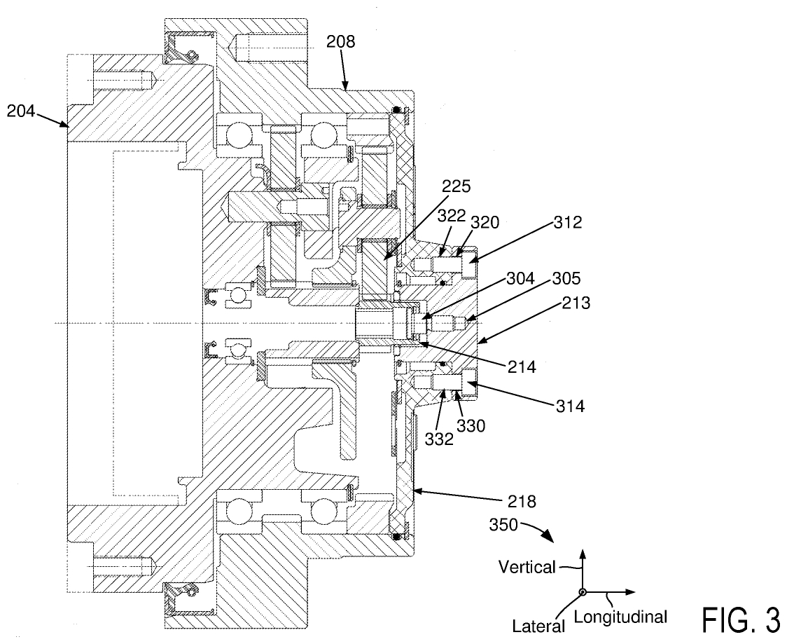

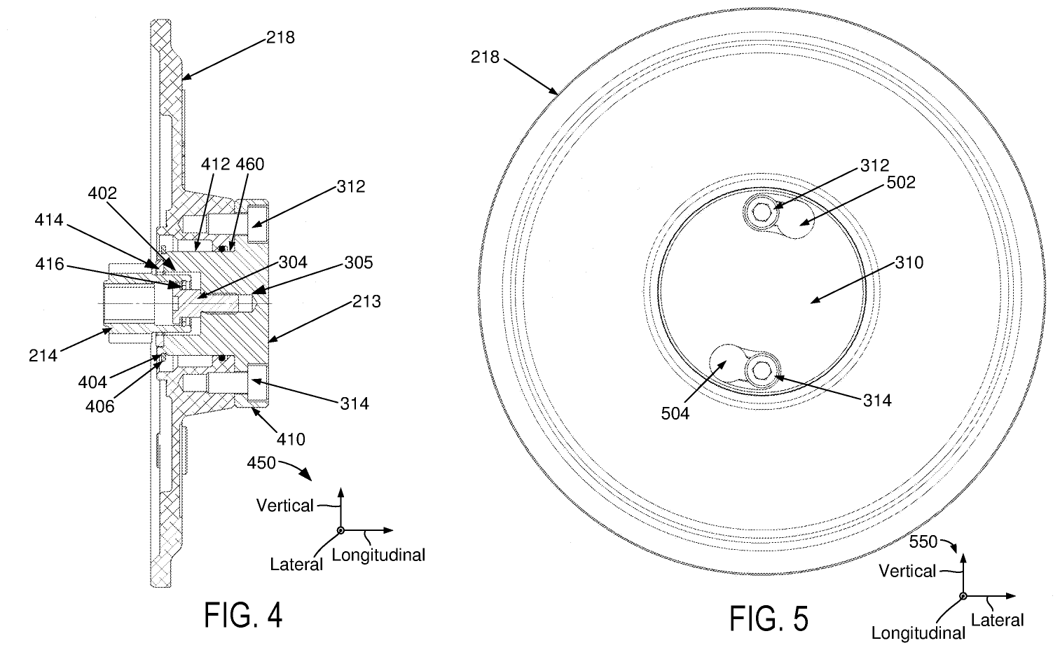

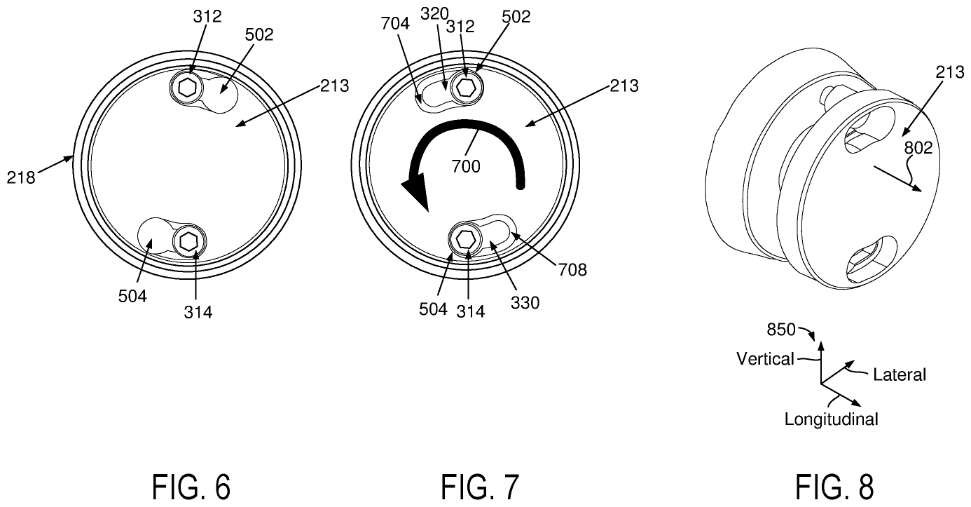

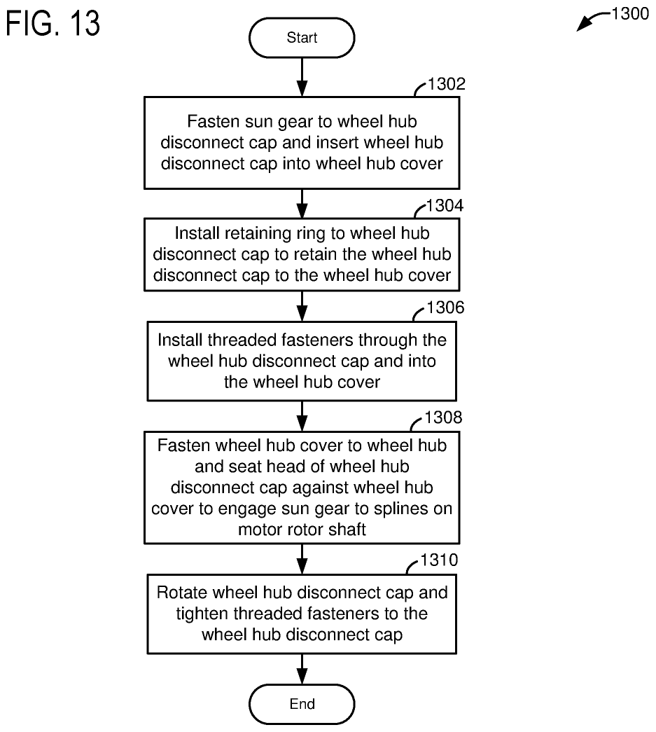

A wheel hub disconnect system is described. The wheel hub disconnect system may disconnect or connect a wheel hub to a propulsion source so that wheels of a vehicle may rotate with or independently from the propulsion source. The wheel hub may be disconnected from the propulsion source during conditions where power is not available to operate the propulsion source or when a vehicle is transported to a different location via a second vehicle. In one example, the vehicle may be of the type that is shown in FIG. 1. However, the wheel hub disconnect system may be applied to other types of vehicles such that it may be appreciated that the vehicle type shown in FIG. 1 is non-limiting. The wheel hub disconnect system may be part of an electrified wheel drive system as is shown in FIGS. 2A and 2B. A detailed view of a gearbox that is included in the electrified wheel drive system is shown in FIG. 3. A detailed cross-section of a wheel hub for the wheel drive system of FIG. 2A is shown in FIG. 4. A plan view of the wheel hub is shown in FIG. 5. Views of a wheel hub disconnect cap during a wheel hub disconnecting and connecting sequence is shown in FIGS. 6-12. Finally, a method for constructing a wheel disconnect system is shown in FIG. 13.

FIGS. 1-12 are drawn approximately to scale. However, the wheel hub disconnect system described herein may have other relative component dimensions in alternate embodiments.

FIG. 1 a plan view of an example vehicle 100 in which electrified wheel drive units 104 of the type that is described herein is shown. In this example, vehicle 100 is a forklift with rear wheels 102. Each electrified wheel drive unit 104 may be selectively coupled to a wheel 102. Electric energy storage device (e.g., a battery or capacitor) 120 may supply electric energy to electrified wheel drive units 104. Front wheels 108 may not be turned. Conversely, rear wheels may pivot to steer vehicle 100.

Referring now to FIG. 2A, a cross-section of electrified wheel drive unit 104 where the wheel hub disconnect system is engaged is shown. Electrified wheel drive unit 104 includes an electric machine 202 that may provide propulsive effort to vehicle 100. Electric machine 202 is shown fastened to wheel hub carrier 204. Electric machine includes a rotor shaft 203. Friction based wheel slowing device 206 is shown positioned between electric machine 202 and wheel hub carrier 204.

Wheel hub carrier 204 supports electric machine 202 and forms one side of gearbox 210. The other side of gearbox 210 is formed by wheel hub 208. Wheel hub carrier 204 holds stator 277 of electric machine 202 in a fixed position while rotor shaft 203 may be rotating. Wheel hub 208 may rotate with rotor shaft 203 when wheel hub 208 is engaged with rotor shaft 203. In particular, sun gear 214 may be fit over splines 212 on rotor shaft 203 when wheel hub disconnect cap 213 is seated against wheel hub cover 218 as shown. Sun gear 214 engages with planetary gear 225 when sun gear 214 is engaged to splines 212. Planetary gear 225 may engage sun gear 214 and wheel hub 208. A wheel (not shown) may be fastened to wheel hub 208.

Axes 250 shows the longitudinal, vertical, and lateral directions with respect to electrified wheel drive unit 104. Thus, rotor shaft 203 extends in a longitudinal direction from electric machine 202 to gear box 210.

Electric power may be applied to electric machine 202 so as to rotate rotor shaft 203. Rotor shaft 203 may transfer torque to sun gear 214 and sun gear 214 may transfer torque to planetary gear 218 so that wheel hub 208 may rotate about wheel hub carrier when sun gear 214 is engaged with splines 212 as shown. Sun gear 214 may be disengaged from splines 212 and planetary gear 225 by moving wheel hub disconnect cap 213 in a longitudinal direction away from wheel hub cover 218.

Moving on to FIG. 2B, view a portion of cross-section of electrified wheel drive unit 104 where the wheel hub disconnect system is disengaged is shown. This view is similar to the view shown in FIG. 2A; however, wheel hub disconnect cap 213 has been moved in a longitudinal direction to a position where sun gear 214 no longer engaged planetary gear 225. Even so, sun gear 214 remains engaged with splines 212 of rotor shaft 203. A small amount of overlap remains between sun gear 214 and rotor shaft 203 as indicated at 230 so that sun gear 214 need not be adjusted in a clockwise or counter-clockwise direction to reengaged with rotor shaft 203. Thus, the wheel hub disconnect system may be reengaged by simply advancing the wheel hub disconnect cap 213 in a longitudinal direction toward wheel hub 208 and wheel hub carrier 204.

Axes 250 shows the longitudinal, vertical, and lateral directions with respect to electrified wheel drive unit 104.

Turning now to FIG. 3, a detailed cross-section of wheel hub carrier 204 and wheel hub 208 is shown. In this view, electric machine 202 has been removed. Further, FIG. 3 shows sun gear retainer 304 (e.g., a bolt or stud) inserted into threaded hole 305 such that it may retain sun gear 214 to wheel hub disconnect cap 213. FIG. 3 also shows a first threaded fastener 312 that is configured to operate as a guide and retainer. First threaded fastener 312 is shown passing through a first slot 320 in wheel hub disconnect cap 213. First threaded fastener 312 is also shown passing into threaded hole 322 in wheel hub cover 218. Second threaded fastener 314 is shown passing through a second slot 330 in wheel hub disconnect cap 213. Second threaded fastener 314 is also shown passing into threaded hole 332 in wheel hub cover 218. Vertical, longitudinal, and lateral directions with respect to wheel hub carrier 204 and wheel hub 208 are shown at axes 350.

Referring now to FIG. 4, a cross-section of wheel hub cover 218 is shown. In this view, wheel hub disconnect cap 213 is shown in its seated position where sun gear 214 would be engaging splines 212 (see FIG. 2A) and planetary gear 225 (see FIG. 2A) so as to engage wheel hub 208 to rotor shaft 203 (see FIG. 2A). Wheel hub disconnect cap 213 includes a head 410 and a shank 412. A diameter of head 410 is greater than a diameter of shank 412. Wheel hub disconnect cap 213 also includes a counter bore 402 that is concentric with threaded hole 305. Counter bore 402 is configured to receive sun gear 214. Shank 412 is shown within through hole 460 of wheel hub cover 218. Wheel hub disconnect cap 213 is retained within through hole 460 of wheel hub cover 218 via retainer ring 406 and head 410. Retainer ring 406 is inserted into retaining ring slot 404. First threaded fastener 312 and second threaded fastener 314 are shown in their respective seated positions where they retain wheel hub disconnect cap 213 in a position to engage wheel hub 208 to rotor shaft 203. Sun gear retainer 304 is retained to wheel hub disconnect cap 213 via internal retaining ring 416. Internal retaining ring 416 pulls sun gear retainer 304 during the disconnect process. Thrust washer 414 aids in reconnection of wheel hub 208 and it also provides a thrust surface. Vertical, longitudinal, and lateral directions with respect to wheel hub carrier 204 and wheel hub 208 are shown at axes 450.

Referring now to FIG. 5, a plan view of wheel hub cover 218 and wheel hub disconnect cap 213 is shown. Wheel hub cover 218 is circular and its diameter is greater than a diameter of wheel hub disconnect cap 213, which is also circular. First threaded fastener 312 and second threaded fastener 314 are shown in their respective seated positions where they hold wheel hub disconnect cap 213 seated against wheel hub cover 218 and where they reduce a possibility of wheel hub disconnect cap 213 from rotating. In this view, first through hole 502 and second through hole 504, both of which pass through wheel hub disconnect cap 213 are shown. These through holes allow wheel hub disconnect cap 213 to move in a longitudinal direction when first threaded fastener 312 and second threaded fastener 314 are loosened so as to allow wheel hub disconnect cap 213 to be rotated. Vertical, longitudinal, and lateral directions with respect to wheel hub carrier 204 and wheel hub 208 are shown at axes 550.

Moving on to FIG. 6, a first part of a sequence for disengaging a wheel hub from a propulsion source is shown. In this view, wheel hub disconnect cap 213 is show, but just a fraction of wheel hub cover 218 is shown. FIGS. 7-12 likewise show just a portion of wheel hub cover 218. Wheel hub disconnect cap 213 is shown in its seated position where wheel hub 208 (not shown) is engaged with rotor shaft 203 (not shown). Here, first threaded fastener 312 and second threaded fastener 314 are tightened against wheel hub disconnect cap 213 so as to reduce a possibility of wheel hub disconnect cap 213 from rotating or moving in a longitudinal direction. First through hole 502 and second through hole 504 are also visible.

Referring now to FIG. 7, a view of how wheel hub disconnect cap 213 may be indexed or rotated counter-clockwise to begin decoupling the wheel hub is shown. In this view, first slot 320 and second slot 330 are visible after wheel hub disconnect cap 213 has been rotated as indicated by arrow 700. Prior to rotating wheel hub disconnect cap 213, first threaded fastener 312 and second threaded fastener 314 are loosened. From this view, first counter bore 704, which follows and is adjacent to slot 320, is visible. Further, second counter bore 708, which follows and is adjacent to slot 330 is also visible. The counter bores allow heads of first threaded fastener and second threaded fastener to tighten against and hold wheel hub disconnect cap 213 in place. Wheel hub disconnect cap 213 is shown rotated such that first threaded fastener 312 aligns with first through hole 502 and second threaded fastener aligns with second through hole 504. This allows wheel hub disconnect cap 213 to be moved in a longitudinal direction with respect to electrified wheel drive unit 104 (not shown) as shown in FIG. 8.

Referring now to FIG. 8, wheel hub disconnect cap 213 is shown in a position where wheel hub 208 (not shown) is disconnected from rotor shaft 203 (not shown). In particular, wheel hub disconnect cap 213 has been moved in a longitudinal direction as indicated by arrow 802 so that wheel hub disconnect cap 213 is no longer seated to or against wheel hub cover 218 (not shown). By moving the wheel hub disconnect cap 213 longitudinally as shown, sun gear 214 disconnects the coupling of rotor shaft 203 to wheel hub 208. Vertical, longitudinal, and lateral directions with respect to wheel hub carrier 204 and wheel hub 208 are shown at axes 850.

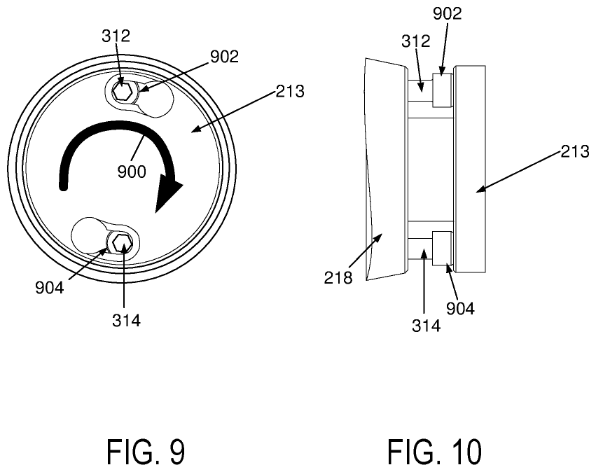

Referring now to FIG. 9, wheel hub disconnect cap 213 is shown in a position where it has been moved in a longitudinal direction so that head 902 of first threaded fastener 312 and head 904 of second threaded fastener 314 clear wheel hub 208 (not shown). Further, wheel hub disconnect cap 213 has been rotated in a clock-wise direction as indicated by arrow 900 so that first threaded fastener 312 and second threaded fastener 314 may be positioned to reduce a possibility of wheel hub 208 (not shown) from reengaging rotor shaft 203 (not shown).

Referring now to FIG. 10, a view that illustrates how first threaded fastener 312 and second threaded fastener 314 may be positioned to reduce a possibility of wheel hub 208 (not shown) from reengaging rotor shaft 203 (not shown) is shown. In particular, first threaded fastener 312 and second threaded fastener 314 are rotated in a counter-clockwise direction so that head 902 and head 904 impinge on wheel hub disconnect cap 213. The previously mentioned counter bores (e.g., 704 and 708 of FIG. 7) that are adjacent to the slots (e.g., 320 and 330 of FIG. 3) of wheel hub disconnect cap 213 provide a surface that first threaded fastener 312 and second threaded fastener 314 may apply force to, thereby restraining wheel hub disconnect cap 213 from moving toward the wheel hub cover 218.

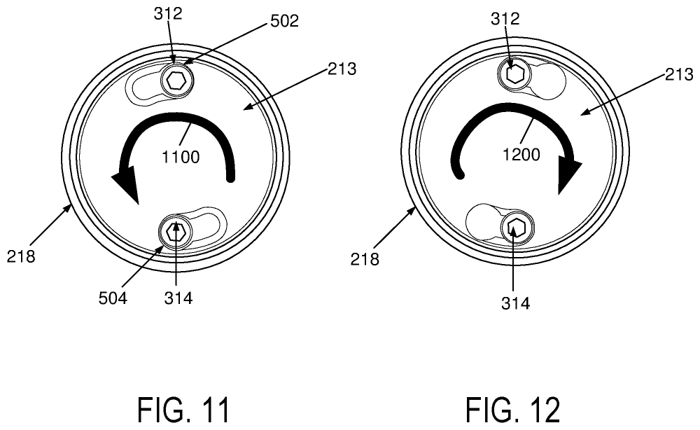

Referring now to FIG. 11, a view that illustrates how wheel hub disconnect cap 213 may be repositioned to recouple wheel hub 208 to rotor shaft 203 is shown. In order to move from the position shown in FIG. 10 to the position shown in FIG. 11, first threaded fastener 312 and second threaded fastener are rotated in a clockwise direction. Further, wheel hub disconnect cap 213 is rotated in a counter-clockwise direction as indicated by arrow 1100. The wheel hub disconnect cap 213 is now positioned so that first threaded fastener 312 may pass through first through hole 502 and the second threaded fastener 314 may pass through second through hole 504. The wheel hub disconnect cap 213 may be moved in a longitudinal direction such that it is seated against wheel hub cover 218, thereby moving sun gear 214 to recouple rotor shaft 203 to wheel hub 208.

Referring now to FIG. 12, a view that illustrates how wheel hub disconnect cap 213 may be repositioned to lock wheel hub 208 to rotor shaft 203 is shown. In order to move from the position shown in FIG. 11 to the position shown in FIG. 12, wheel hub disconnect cap 213 is rotated in a clockwise direction as indicated by arrow 1200 after the wheel hub disconnect cap 213 is seated against the wheel hub cover 218. The first threaded fastener 312 and the second threaded fastener 314 may be tightened so that the possibility of wheel hub disconnect cap 213 moving may be reduced.

In this way, FIGS. 6-12 illustrate how the wheel hub disconnect cap may be operated to engage and disengage a wheel hub from a propulsion source. Further, threaded fasteners may be used to hold the wheel hub in a desired state (e.g., engaged or disengaged from the propulsion source).

Thus, the system of FIGS. 1-12 provides for a wheel disconnect system, comprising: a wheel hub disconnect cap, the wheel hub disconnect cap comprising a circular head and a circular shank, a first through hole, and a second through hole. In a first example, the wheel disconnect system further comprises a first slot in communication with the first through hole and a second slot in communication with the second through hole. In a second example that may include the first example, the wheel disconnect system further comprises a first counter bore adjacent to the first slot and a second counter bore adjacent to the second slot. In a third example that may include one or both of the first and second examples, the wheel disconnect system further comprises a retaining ring slot. In a fourth example that may include one or more of the first through third examples, the wheel disconnect system further comprises a first bore hole in the circular shank and a second bore hole in the circular shank. In a fifth example that may include one or more of the first through fourth examples, the wheel disconnect system includes where the first bore hole is concentric with the second bore hole. In a sixth example that may include one or more of the first through fifth examples, the wheel disconnect system further comprises a sun gear retainer at least partially inserted into the first bore hole, a sun gear at least partially inserted into the second bore hole, the sun gear retained to the wheel hub disconnect cap via the sun gear retainer. In a seventh example that may include one or more of the first through sixth examples, the wheel disconnect system further comprises a retaining ring at least partially inserted into the retaining ring slot. In an eighth example that may include one or more of the first through seventh examples, the wheel disconnect system further comprises a first threaded fastener passing through the wheel hub disconnect cap and a second threaded fastener passing through the wheel hub disconnect cap. In a ninth example that may include one or more of the first through eighth examples, the wheel disconnect system further comprises a wheel hub, the circular shank inserted at least partially into the wheel hub via a through hole in the wheel hub. In a tenth example that may include one or more of the first through ninth examples, the wheel disconnect system further comprises a first bore hole in the wheel hub configured to receive the first threaded fastener, a second bore hole in the wheel hub configured to receive the second threaded fastener.

The system of FIGS. 1-12 also provides for a wheel disconnect system, comprising: wheel hub carrier; a wheel hub fastened to the wheel hub carrier; an electric machine fastened to the wheel hub carrier; and a wheel hub disconnect cap fastened to the wheel hub, the wheel hub disconnect cap comprising a circular head and a circular shank, a first through hole, and a second through hole. In a first example, the wheel disconnect system further comprises a sun gear fastened to the wheel hub disconnect cap, and where the sun gear remains in contact with a rotor shaft of the electric machine when the wheel disconnect system is engaged and disengaged. In a second example that may include the first example, the wheel disconnect system further comprises a planetary gear in selective communication with the sun gear. In a third example that may include one or both of the first and second examples, the wheel disconnect system further comprises a first fastener passing through the first through hole and a second fastener passing through the second through hole. In a fourth example that may include one or more of the first through third examples, the wheel disconnect system further comprises a retaining ring retaining the wheel hub disconnect cap to the wheel hub.

Referring now to FIG. 13, a method for constructing a wheel disconnect system is shown. The method of FIG. 13 may be performed by a human or by machines on an assembly line. The method of FIG. 13 may be applied to produce the wheel disconnect system that is described herein.

At 1302, method 1300 fastens a sun gear to a wheel hub disconnect cap and inserts the wheel hub disconnect cap into a wheel hub cover (e.g., a shown in FIGS. 2-4). This allows the sun gear to move with the wheel hub disconnect cap to engage and disengage a wheel hub to a propulsion source. Method 1300 proceeds to 1302.

At 1304, method 1300 installs a retaining ring to the wheel hub disconnect cap to retain the wheel hub disconnect cap to the wheel hub cover. The retaining ring ensures that the wheel hub disconnect cap and the wheel hub cover do not become uncoupled when disengaging the wheel hub. Method 1300 proceeds to 1306.

At 1306, method 1300 installs threaded fasteners through the wheel hub disconnect cap and into the wheel hub cover. The threaded fasteners may reduce a possibility of unintended movement of the wheel hub disconnect cap. Method 1300 proceeds to 1308.

At 1308, method 1300 fastens the wheel hub cover to the wheel hub and seats the wheel hub disconnect cap to or against the wheel hub cover. To seat the wheel hub disconnect cap, the wheel hub disconnect cap is inserted into the wheel hub cover. Seating the wheel hub disconnect cap causes the sun gear to engage splines of a motor rotor shaft and teeth of one or more planetary gears, thereby engaging the wheel hub to a propulsion source. Method 1300 proceeds to 1310.

At 1310, method 1300 rotates the wheel hum disconnect cap and tightens the threaded fasteners to the wheel hub disconnect cap so that the wheel hub disconnect cap may be restricted from moving. Method 1300 proceeds to exit.

Thus, a wheel hub disconnect cap may be rotated and moved in a longitudinal direction to engage and disengage a wheel hub from a propulsion source. The wheel hub disconnect cap and associated components may reduce a possibility of lost pieces and unintentional changes in the operating state of the wheel hub disconnect system.

Thus, the method of FIG. 13 provides for a method for constructing a wheel disconnect system, comprising: fastening a sun gear to a wheel hub disconnect cap; inserting the wheel hub disconnect cap into a wheel hub cover; and installing a retaining ring to the wheel hub disconnect cap to retain the wheel hub disconnect cap to the wheel hub cover. In a first example, the method further comprises installing two fasteners through the wheel hub disconnect cap and into the wheel hub cover. In a second example that may include the first example, the method further comprises fastening the wheel hub cover to a wheel hub and seating a head of the wheel hub disconnect cap against the wheel hub cover to engage the sun gear to a splined shaft. In a third example that may include one or both of the first and second examples, the method further comprises rotating the wheel hub disconnect cap and tightening the two fasteners to the wheel hub disconnect cap.

While various embodiments have been described above, it may be understood that they have been presented by way of example, and not limitation nor restriction. It will be appreciated that the configurations and routines disclosed herein are exemplary in nature, and that these specific examples are not to be considered in a limiting sense, because numerous variations are possible. For example, the above technology can be applied to powertrains that include different types of propulsion sources including different types of electric machines, internal combustion engines, and/or transmissions. The technology may be used as a stand-alone, or used in combination with other power transmission systems not limited to machinery and propulsion systems for tandem axles, electric tag axles, P4 axles, HEVs, BEVs, agriculture, marine, motorcycle, recreational vehicles and on and off highway vehicles, as an example. The subject matter of the present disclosure includes all novel and non-obvious combinations and sub-combinations of the various systems and configurations, and other features, functions, and/or properties disclosed herein. It will be apparent to persons skilled in the relevant arts that the disclosed subject matter may be embodied in other specific forms without departing from the spirit of the subject matter.

The following claims particularly point out certain combinations and sub-combinations regarded as novel and non-obvious. These claims may refer to “an” element or “a first” element or the equivalent thereof. Such claims may be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

As used herein, the term “approximately” is construed to mean plus or minus five percent of the range, unless otherwise specified.

1. A wheel disconnect system, comprising:
a wheel hub disconnect cap, the wheel hub disconnect cap comprising a circular head and a circular shank, a first through hole, and a second through hole.

2. The wheel disconnect system of claim 1, further comprising a first slot in communication with the first through hole and a second slot in communication with the second through hole.

3. The wheel disconnect system of claim 2, further comprising a first counter bore adjacent to the first slot and a second counter bore adjacent to the second slot.

4. The wheel disconnect system of claim 3, further comprising a retaining ring slot.

5. The wheel disconnect system of claim 4, further comprising a first bore hole in the circular shank and a second bore hole in the circular shank.

6. The wheel disconnect system of claim 5, where the first bore hole is concentric with the second bore hole.

7. The wheel disconnect system of claim 6, further comprising a sun gear retainer at least partially inserted into the first bore hole, a sun gear at least partially inserted into the second bore hole, the sun gear retained to the wheel hub disconnect cap via the sun gear retainer.

8. The wheel disconnect system of claim 7, further comprising a retaining ring at least partially inserted into the retaining ring slot.

9. The wheel disconnect system of claim 1, further comprising a first threaded fastener passing through the wheel hub disconnect cap and a second threaded fastener passing through the wheel hub disconnect cap.

10. The wheel disconnect system of claim 9, further comprising a wheel hub, the circular shank inserted at least partially into the wheel hub via a through hole in the wheel hub.

11. The wheel disconnect system of claim 10, further comprising a first bore hole in the wheel hub configured to receive the first threaded fastener, a second bore hole in the wheel hub configured to receive the second threaded fastener.

12. A method for constructing a wheel disconnect system, comprising:
fastening a sun gear to a wheel hub disconnect cap;
inserting the wheel hub disconnect cap into a wheel hub cover; and
installing a retaining ring to the wheel hub disconnect cap to retain the wheel hub disconnect cap to the wheel hub cover.

13. The method of claim 12, further comprising installing two fasteners through the wheel hub disconnect cap and into the wheel hub cover.

14. The method of claim 13, further comprising fastening the wheel hub cover to a wheel hub and seating a head of the wheel hub disconnect cap against the wheel hub cover to engage the sun gear to a splined shaft.

15. The method of claim 14, further comprising rotating the wheel hub disconnect cap and tightening the two fasteners to the wheel hub disconnect cap.

16. A wheel disconnect system, comprising:
wheel hub carrier;
a wheel hub fastened to the wheel hub carrier;
an electric machine fastened to the wheel hub carrier; and
a wheel hub disconnect cap fastened to the wheel hub, the wheel hub disconnect cap comprising a circular head and a circular shank, a first through hole, and a second through hole.

17. The wheel disconnect system of claim 16, further comprising a sun gear fastened to the wheel hub disconnect cap, and where the sun gear remains in contact with a rotor shaft of the electric machine when the wheel disconnect system is engaged and disengaged.

18. The wheel disconnect system of claim 17, further comprising a planetary gear in selective communication with the sun gear.

19. The wheel disconnect system of claim 18, further comprising a first fastener passing through the first through hole and a second fastener passing through the second through hole.

20. The wheel disconnect system of claim 19, further comprising a retaining ring retaining the wheel hub disconnect cap to the wheel hub.
